(19) United States
(12) Patent Application Publication
(10) Pub. No.: US 2015/0302425 A1
(43) Pub. Date: Oct. 22, 2015

(54) ASSIGNING PRIORITY LEVELS TO CITIZEN SENSOR REPORTS

(71) Applicant: International Business Machines Corporation, Armonk, NY (US)

(72) Inventors: Sergio BORGER, Sao Paulo (BR); Carlos Henrique CARDONHA, Sao Paulo (BR); Fernando KOCH, Florianopolis (BR); Jan Marcel Paiva IENTILE, Sao Paulo (BR)

(73) Assignee: International Business Machines Corporation, Armonk, NY (US)

(21) Appl. No.: 14/258,728

(22) Filed: Apr. 22, 2014

(51) Int. Cl. G06Q 30/02; G06Q 10/06

(52) U.S. Cl. CPC G06Q 30/0201; G06Q 10/0637; G06Q 50/01

(57) ABSTRACT

Various embodiments prioritize incidents associated with citizen sensor reports. In one embodiment, a plurality of citizen sensor reports is received from a plurality of users. A context associated with each of the plurality of citizen sensor reports is determined. A set of citizen sensor reports associated with at least one incident from a plurality of different incidents is identified based on the determined context. A severity level of the incident associated with the set of citizen sensor reports is calculated for each of the set of citizen sensor reports based on a reputation value assigned to each of a set of users who generated the set of citizen sensor reports. Each of the plurality of incidents is prioritized based on their calculated severity levels.

### BACKGROUND

The present disclosure generally relates to citizen sensor reporting, and more particularly relates to assigning priority levels to citizen sensor reports.

Citizen sensor networks are an emerging paradigm in social computing research. In particular, a citizen sensor network is a network of interconnected participatory citizens who provide observations (or reports) in a specific context. These observations/reports can be used to classify a characteristic(s) or resource(s) of a given domain.

### BRIEF SUMMARY

In one embodiment, a method for prioritizing incidents associated with citizen sensor reports is disclosed. The method comprises receiving a plurality of citizen sensor reports from a plurality of users. A context associated with each of the plurality of citizen sensor reports is determined. A set of citizen sensor reports associated with at least one incident from a plurality of different incidents is identified based on the determined context. A severity level of the incident associated with the set of citizen sensor reports is calculated for each of the set of citizen sensor reports based on a reputation value assigned to each of a set of users who generated the set of citizen sensor reports. Each of the plurality of incidents is prioritized based on their calculated severity levels.

In another embodiment, an information processing system for prioritizing incidents associated with citizen sensor reports is disclosed. The information processing system comprises a memory and a processor communicatively coupled to the memory. A priority level manager is communicatively coupled to the memory and the process. The priority level manager is configured to perform a method. The method comprises receiving a plurality of citizen sensor reports from a plurality of users. A context associated with each of the plurality of citizen sensor reports is determined. A set of citizen sensor reports associated with at least one incident from a plurality of different incidents is identified based on the determined context. A severity level of the incident associated with the set of citizen sensor reports is calculated for each of the set of citizen sensor reports based on a reputation value assigned to each of a set of users who generated the set of citizen sensor reports. Each of the plurality of incidents is prioritized based on their calculated severity levels.

In a further embodiment, a computer program product for prioritizing incidents associated with citizen sensor reports is disclosed. The computer program product comprises a storage medium readable by a processing circuit and storing instructions for execution by the processing circuit for performing a method. The method comprises receiving a plurality of citizen sensor reports from a plurality of users. A context associated with each of the plurality of citizen sensor reports is determined. A set of citizen sensor reports associated with at least one incident from a plurality of different incidents is identified based on the determined context. A severity level of the incident associated with the set of citizen sensor reports is calculated for each of the set of citizen sensor reports based on a reputation value assigned to each of a set of users who generated the set of citizen sensor reports. Each of the plurality of incidents is prioritized based on their calculated severity levels.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a block diagram illustrating a detailed view of an operation center platform for managing citizen sensor reports according to one embodiment of the present disclosure;

FIG. 3 is a block diagram illustrating a detailed view of a system architecture implemented within the operating environment of FIG. 1 according to one embodiment of the present disclosure;

FIG. 4 is a block diagram illustrating one example of a reporting interface for generating citizen sensor reports according to one embodiment of the present disclosure;

FIG. 5 illustrates one example of a user profile according to one embodiment of the present disclosure;

FIG. 6 is an operational flow diagram illustrating one example of an overall process for prioritizing events associated with citizen sensor reports; and

FIG. 7 is a block diagram illustrating one example of an information processing system according to one embodiment of the present disclosure.

### DETAILED DESCRIPTION

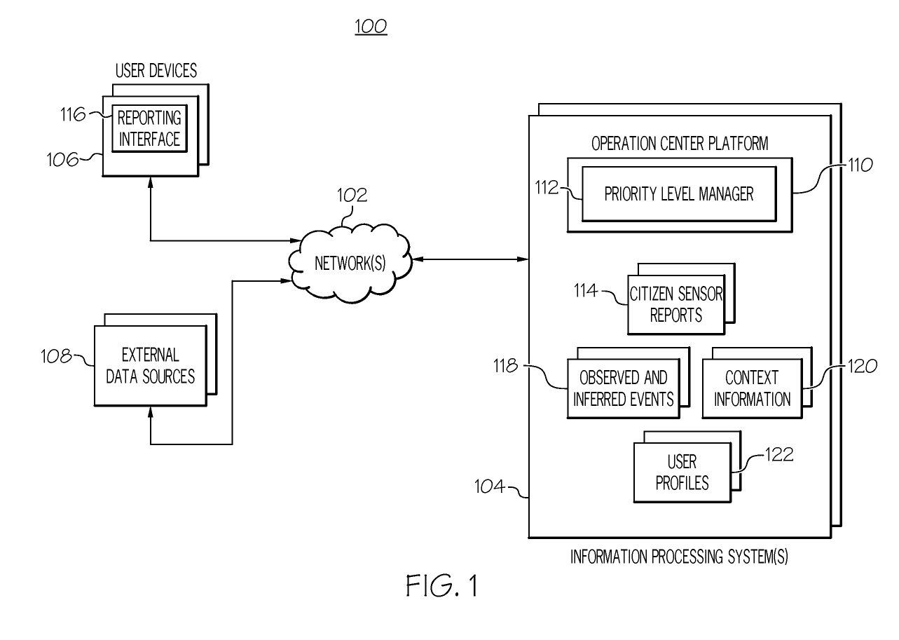

FIG. 1 shows one example of an operating environment 100 for assigning priority levels to citizen sensor reports (CSRs). The operating environment 100 of FIG. 1 can be a cloud computing environment or a non-cloud computing environment. In a cloud computing environment, various embodiments of the present disclosure discussed below are provided as a service. In one embodiment, the operating environment 100 is a citizen sensor platform, which is a network of interconnected participatory citizens who provide intentional and non-intentional observations (or reports) in a specific context. These observations/reports can be used to classify a characteristic(s) or resource(s) of a given domain. This citizen sensor platform instruments citizens and different domains (e.g., cities, organizations, etc.), interconnects parties, analyzes related events, and provides recommendation and feedback reports.

The operating environment 100 comprises one or more networks 102 that, in one embodiment, can include wide area networks, local area networks, wireless networks, telecommunication networks, and/or the like. In one embodiment, the environment 100 includes a plurality of information processing systems 104, 106, 108 that are communicatively coupled to the network(s) 102. The information processing systems 104, 106, 108 include one or more servers 104, user systems 106, and various other external data sources 108. The user systems 106 can include, for example, information processing systems such as desktop computers; servers; portable computing devices such as laptop computers mobile/smart phones, tablets, wearable computing devices (e.g., smart watches), personal digital assistants, etc.; and/or the like. The external data sources 108 comprise various types of sensors such as (but not limited to) cameras, traffic sensors, pollution sensors, weather sensors, and/or the like. The external data sources 108 further comprises various agencies such as weather agencies, traffic agencies, security agencies, health agencies, and/or the like.

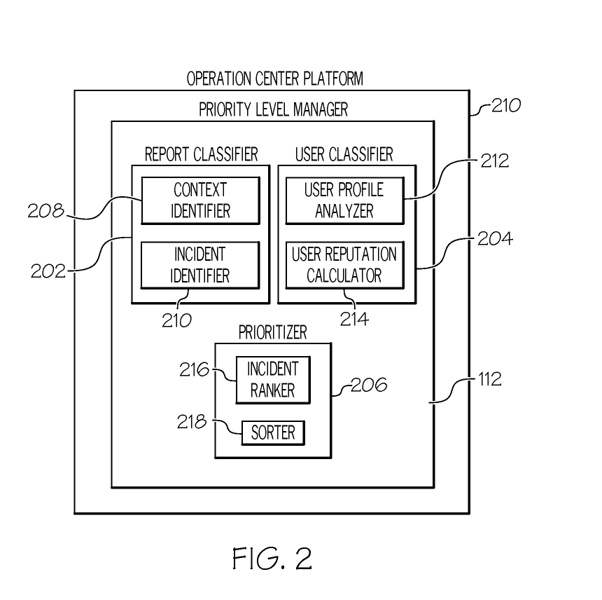

The information processing system 104, in one embodiment, comprises an operation center platform 110. The operation platform includes a priority level manager 112, which comprises a report classifier 202 (FIG. 2), a user classifier 204, and a prioritizer 206. The report classifier 202 includes a context identifier 208 and an incident identifier 210. The user classifier 204 includes a user profile analyzer 212 and a user reputation calculator 214. The prioritizer 206 includes an incident ranker 216 and a sorter 218. The operation center platform 110 and/or one or more of its components may be distributed across a plurality of information processing systems. The components of the operation center platform 110 are discussed in greater detail below.

As will be discussed in greater detail below, the operation center platform 110 collects information from citizen sensor reports 114 generated by user devices 106. In this embodiment, users act as sensors to detect events/situations (herein referred to as “incidents”) in a given environment (domain) and report and/or provide feedback on these incidents. Users generate citizen sensor events/reports 114 using a reporting interface 116 disposed on the user devices 106. A reporting interface 116 comprises, for example, one or more applications and/or application programming interfaces that allow a user to report incidents on the spot. In particular a reporting interface 116 allows a user to enter information regarding a given incident that is presently occurring or that has occurred in the past. For example, using the reporting interface 116 a user is able to provide/report the quality of service received from an employee of an establishment; any observed or perceived security threats; current traffic/road conditions; observed pollution; public illumination problems; and/or the like. Users are able to annotate their reports with photographs, videos, notes, voice recordings, and pre-classified attributes.

The information entered into the reporting interface 116 by the user is referred to herein as a citizen sensor event (CSE) that mark events/situations observed or experienced by the user. The reporting interface 116 sends these CSEs to the operation center platform 110 as a citizen sensor reports (CSRs) 114. In another embodiment, a CSR 114 further comprises automated sensed information associated with the reported incident. Automated sensed information comprises data such as (but not limited to) situational data and local context data. Situational data comprises information such as (but not limited to) time, user device location, orientation, and/or the like. Local context data comprises information related to the environment surrounding the location where the reported incident took place. For example, local context data can comprise related events; surrounding parties; surrounding objects; still images, video, and audio of the surrounding environment; weather information, pollution information, traffic information, health information, and/or the like.

In one embodiment, the reporting interface 116 obtains automated sensed information from the user device 106 itself and/or one or more external data sources 108 such as (but not limited to) external sensors and/or agencies. The reporting interface 116 sends the automated sensed information for a reported incident to the operation center platform 110 along with the CSEs. In this embodiment, a CSR 114 is the combination of end-users' entered information/annotations and automated sensed information. It should be noted that the operation center platform 110 can obtain automated sensed information for a reported incident upon receiving the CSR 114.

The operation center platform 110 stores, indexes, and groups the information provided by the citizen sensor reports 114. The operation center platform 110 processes this information by applying one or more analytical models to the information, generating various reports, and/or the like. For example, the operation center platform 110 applies one or more analytical models to the reports 114 to identify events observed by users and/or external data sources, and to also infer events that have occurred. The operation center platform 110 stores these events as observed and inferred events 118. The operation center platform 110 also determines the context associated with the observed and inferred events 118, and stores a set of context information 120 for the events 118.

In one embodiment, the operation center platform 110 assigns priority levels to CSRs 114 being collected on-spot by end-users through the reporting interfaces 116. The operation center platform 110 establishes a hierarchy among incidents reported in large sets of citizen sensor events (CSEs) identified from the CSRs 114. A priority level is assigned to these events based upon distinct characteristics of the CSRs 114 such as (but not limited to) time-sensitiveness, open environment context, end-user profiles 122 and end-user reputation, in combination with generated user reputation rates, and parameters of the local context. For example, the operation center platform 110 is able to prioritize incoming CSRs 114 based on characteristics of the local context (e.g. time, location, and surrounding activities) and an end-user's historical behavior while generating CSRs 114. In this example, the operation center platform 110 can decrease the priority of redundant reports and increase the weight of observations made by highly regarded end-users. In addition, the operation center platform 110 is able to filter out redundant reports and/or reports from low-reputation end-users.

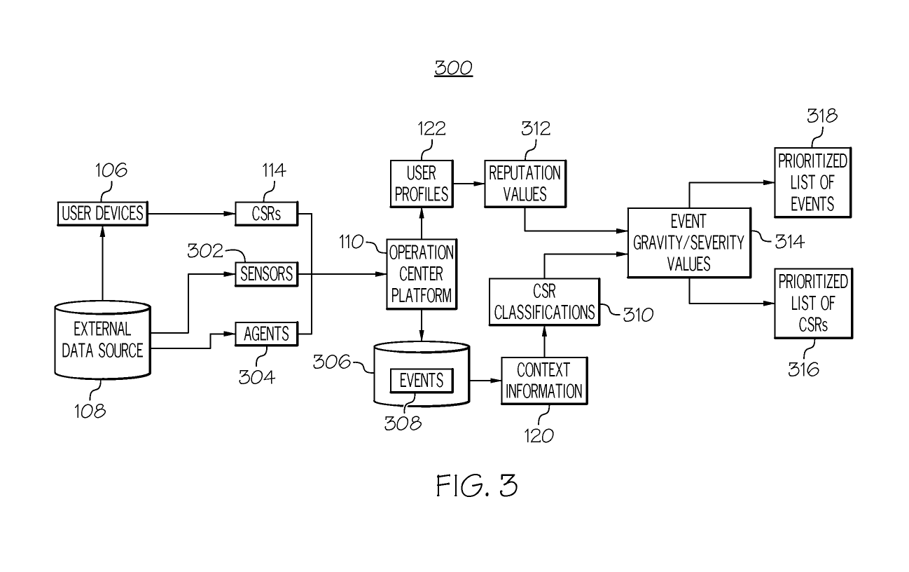

FIG. 3 shows a detailed view of a system architecture 300 implemented within the operating environment 100 of FIG. 1 for prioritizing CSRs. As discussed above, the operation center platform 110 obtains a set of information from external data sources 108 such as user devices 106, sensors 302, and agencies 304. Users report or provide feedback (i.e., intentional sensing) on a given incident that is presently occurring or that has occurred in the past utilizing a reporting interface 116.

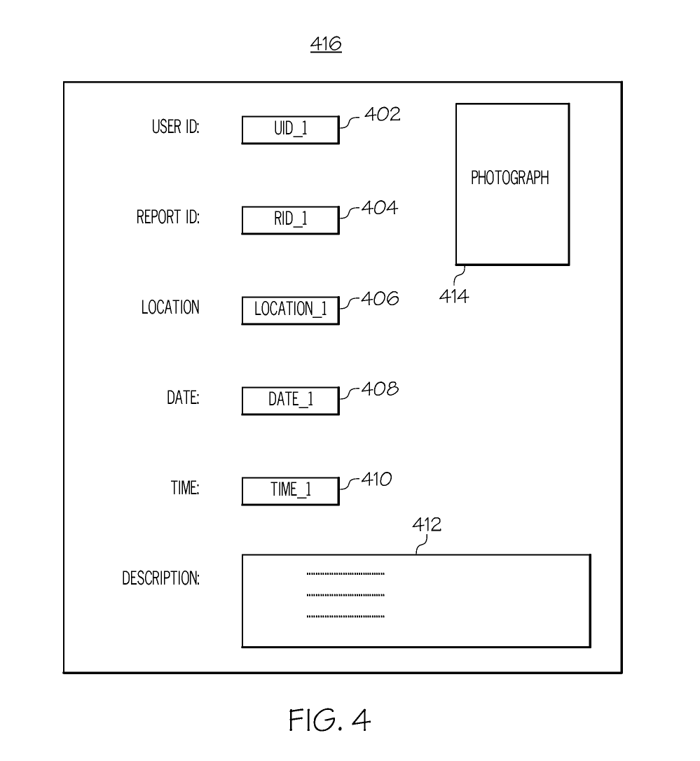

FIG. 4 shows one example of a reporting interface 416. In particular, the reporting interface 416 of FIG. 4 comprises a first field 402 for receiving a unique user identification (ID) associated with the user creating the report; a second field 404 for receiving a unique report ID associated with the report being created; a third field 406 for receiving the location of where the report is being generated; a fourth and fifth field 408, 410 for receiving date and time information, respectively, associated with the incident being reported by the user; and a sixth field 412 for receiving a description of the incident. It should be noted that the information required by one or more of the fields 402, 404, 406, 408, 410, 412 can be automatically entered by the reporting interface 422 and/or manually entered by the user. The reporting interface 422 also comprises an area 414 for storing/displaying a picture of the incident being reported. The user is able to capture a picture and/or a video utilizing his/her user device 106.

It should be noted that a reporting interface 116 can also present information associated with automated sensed incidents to the user such as (but not limited to) traffic conditions, queue/line waiting times, security conditions at a given location; pollution conditions at a given location; illumination conditions at a given location, and/or the like. In this embodiment, the user is able to provide his/her feedback (annotations) regarding the automated sensed information. For example, the reporting interface 116 receives a set of automated sensed information when the user is within at least a given threshold distance from the location associated with the incident. The reporting interface 116 presents this automated sensed information to the user. The user then annotates the information by confirming the automated sensed information, adding a description of the automated sensed information, and/or the like.

Once the user has completed entering information such as CSEs into the reporting interface 116, the user device 106 sends the information entered into the interface 116 to the operation center platform 110 as a CSR 114. It should be noted that in addition to the information/annotations entered into the interface 116, the reporting interface 116 can augment this information with non-intentional (automated sensed) information such as contextual information (e.g., location, user profile, sensor data, and/or the like). For example, the reporting interface 116 can automatically obtain location information (e.g., global positioning satellite information); weather information; pollution information; health information; security threat information; traffic information; and/or the like. In the current example, the reporting interface 116 obtains address information for the service provider entered into the reporting interface 116 by the user; weather information for an area surrounding the service provider; health information related to disease outbreaks in an area surrounding the service provider; and/or the like. This additional information is also sent to the operation center platform 110 as part of or in addition to the CSR 114.

It should be noted that the non-intentional (automated sensed information) can also be provided to the operation center platform 110 by various sensors within or surrounding the location where the incident occurred and/or by one or more agencies. For example, the operation center platform 110 can obtain the weather information for the date(s) and time(s) associated with the CSR 114 from a weather sensor and/or weather agency. The operation center platform 110 can also obtain the health information from a health agency such as the Center for Disease Control and Prevention.

The report classifier 202 of the operation center platform 110 processes the received CSRs 114 to, among other things, identify sets of CSRs associated with the same incidents/events. For example, the report classifier 202 generates a data structure t′ for each received CSRs 114. These data structures 308 are stored within one or more data repositories 306 as events/incidents 308. In one embodiment, a data structure 308 is stored in a tuple format comprising, for example, {userID, eventID, eventType, time, location, element, parameters}, where userID identifies the user who created the CSR 114, eventID is the identifier (ID) of the reported incident, eventType is the type of incident (positive service received from an employee; negative service received from an employee; car accident; traffic jam; security threat; etc.), time indicates when the incident occurred, location indicates the geo-location coordinates of the place where the incident took place, element describes the target of the report (e.g. staff, service, institution, etc.), and parameters detail the incident.

The context identifier 208 of the report classifier 202 processes the information from the CSRs 114, such as the stored events 308, to identify CSRs 114 with similar context(s). For example, the context identifier 208 processes context information 120 (local context parameters) associated with the events 308 identified for each CSR 114. The context identifier 208 processes this context information 120 in relation to CSRs 114 based on categorized parameters of sensed situational parameters including (but not limited to) location, time, related events, social settings, etc.; and analysis of context similarity based on proximity and congruence of context spaces. In this embodiment, the context identifier 208 identifies the context information associated with the CSRs 114, and identifies the CSRs associated with the same or similar incidents. For example, the context identifier 208 compares the time, location, and element information associated with CSRs. CSRs comprising at least time, location, and element matching within a given threshold are classified as being related to the same incident/event. This classification process generates a plurality of classified CSRs 310.

In one embodiment, a context space can be interpreted as an n-dimensional Euclidean space (Rⁿ), where each dimension refers to one contextual element (e.g., time and location). Reports and events are associated to points in this space. That is, each report and event is contextualized according to a tuple (e.g., (t, lat, lon)). Any metric (e.g., Euclidean distance) can be employed to determine the proximity between points in this space and, therefore, proximity and congruence of reports and events in the contextual space.

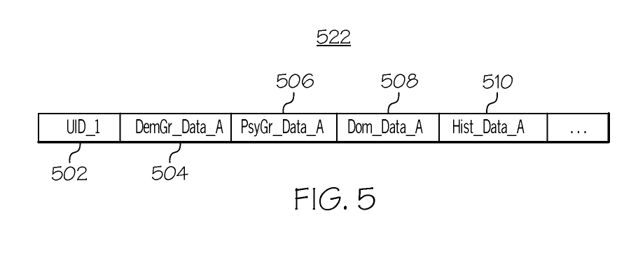

The user classifier 204 analyzes a user profile 122 of the user who created a CSR 114 to determine a user's reputation with respect to CSRs. In this embodiment, a user profile 122 is maintained by the operation center platform 110 for a plurality of registered users. A registered user, in one embodiment, is any user who has downloaded and installed a reporting interface 116. FIG. 5 shows one example of a user profile 522. In this example, the user profile 522 comprises a user ID 502 uniquely identifying the user. The profile 522 also comprises a plurality of categorized information associated with the user. For example, the profile 522 comprises demographic 504, psychographic 506, and domain specific parameters 508. Demographic data can refer to any information that enables the aggregation of individuals (e.g., gender, age, educational level). Psychographics are about personality, attitudes, interests, and lifestyles (e.g., non-smoking, stressed, sedentary). Domain specific traces depend on the application. For example, it can be of interest to know if a person using a Citizen Sensing Application to report about accessibility barriers in a city is a person with disabilities or not. The profile 522 further comprises historical data 510 associated with the user. This historical data 510 comprises information based on a user's previous interactions with a citizen sensor network. For example, the historical data 510 such as the IDs associated with previous CSRs created by the user; feedback from other users regarding the usefulness or correctness of the information provided in the users previously created CSRs; and/or the like. The user profile 522, in one embodiment, is analyzes similar to contextual spaces discussed above. For example, in one embodiment, there is a reputation space for users where each element used to describe a person is mapped into a dimensional of Rⁿ. In this embodiment, most profile information can be fixed and provided by the user. This information can be used to identify people with similar profiles (using, for example, Euclidean distance to make this assessment) and support the evaluation of reports submitted by users whose historical interaction with the system is either inexistent or not really significant (e.g., the user submitted too few reports so far).

In one embodiment, the user classifier 204 takes a tuple of data based on a user's profile 122 and calculates a reputation value for the user. For example, the user classifier 204 takes as input data comprising {userID, hist, catParam}, where userID is the unique identifier of the user, hist is data describing an analysis of the user's historical interaction data, and catParam is data associated with the plurality of categorized information in the user's profile. The user classifier 204 processes this tuple of data and calculates a reputation value 312 for the user with respect to CSRs 114.

In one embodiment, the reputation of the user is a value associated to the user that can change over time. If a system manager and/or other users indicate that a report submitted by this user is false, the person has his/her reputation index reduced (e.g., by 1 or by some other value that reflects the weight and/or reputation of the entity judging the report), or increased. Each positive feedback increases the reputation, and each negative feedback reduces the reputation. The generation of these feedbacks is made by one or more third entities (e.g., other users or a system administrator) and can be given for each report submitted by the user.

The prioritizer 206 of the operation center platform 110 utilizes the CSR classifications 310 and user reputation values 312 to assign a priority level to a set of CSRs by ranking the incidents/events associated with the set of CSRs. In this embodiment, the incident ranker 216 of the prioritizer 206, calculates a gravity/severity value gₑ 314 of an incident/event e assigned to a set of CSRs R (gₑ εR) taking into consideration the reputation 312 of users who created the CSRs in the set of CSRs R. For example, let n be the number of users, r_{uεR} εR denote the reputation value of the user u, and X_{u,e} be an optional binary variable indicating if user u submitted reports related to event e. The incident ranker 216 calculates the gravity value gₑ εR of event e as given by:

$${g}_{e} = {\sum }_{u = 1}^{n} {X}_{u , e} {r}_{u} , \qquad ( EQ 1 )$$

where gₑ is well-defined for every value of gₑ, i.e., denominators are larger or equal to 1.

In one embodiment, individual CSRs can be prioritized according to the gravity of the events and to the reputation of the users associated to it. For example, the rating of report can be equal to the gravity gₑ of the associate event e multiplied by the reputation index of its users. This way, a report with high gravity submitted by a user with high reputation appears on the top of the list, while reports submitted by “bad” users would appear in the end. In another embodiment, CSRs can also be prioritized based exclusively on their users' reputation or on their associated events' gravity.

The gravity value gₑ indicates the level of severity of an incident with respect to other incidents. The sorter 218 of the prioritizer 206 performs one or more sorting operations on the incidents based on the calculated gravity values of the incidents. In one example, a list of prioritized incidents/events 316 is generated with the incident comprising the highest severity (based on the gravity value gₑ) being at the top of the list 316 and the incident with the lowest severity being at the bottom of the list 316. This prioritized list 316 can then be presented to an entity who can take appropriate actions with respect to the incidents based on their severity.

For example, consider a city implementing the operation center platform 110. The city provides a reporting interface 116 to its citizens enabling them to send reports identifying the occurrence of various events such as, but not limited to, pot holes in the street, traffic conditions, graffiti, illumination problems, and/or the like. In a large city, a high number of daily complaints are to be expected, and can surpass the city's capacity to solve each issue immediately. Therefore, it is crucial for the city to identify the most severe/impacting events and give preference to these issues over the other reported problems.

In another embodiment, the prioritizer 206 not only determines the severity of incidents, but also assigns priority levels to CSRs 114 based on their associated incidents. In this embodiment, the prioritizer 206 compares the reputation value 312 of each user who generated report in a set of CSRs 114 associated with the same (or similar) incident. The prioritizer 206 then assigns, based on the comparing, a priority level to each of the citizen sensor reports in the set of citizen sensor reports 114, where a first citizen sensor report associated with a first reputation value that is higher than a second reputation value associated with a second citizen sensor report is assigned a higher priority level than the second citizen sensor report.

The prioritizer 206 also assigns priority levels to incoming CSRs 114 based on their associated incidents. In this embodiment, an incoming CSR 114 is analyzed to identify its {time, location, element} information or {time, location, type, element} information. Based on this information, the report classifier 202 identifies an incident/event being reported by the CSR 114. The prioritizer 206 identifies the gravity value gₑ of the incident associated with the CSR 114. Then, based on the identified gravity value gₑ, the prioritizer 206 assigns a priority level to the CSR. In one embodiment, the higher the gravity value gₑ of the associated incident, the higher the priority level assigned to the CSR 114. The prioritizer 206 then generates a prioritized list 318 of CSRs 114 based on the priorities assigned to the CSRs 114. Therefore, CSRs 114 associated with an incident of higher severity can be identified and given preference over CSRs 114 associated with an incident of lesser severity. In addition, the prioritizer 206 can filter CSRs based on their priority levels as well.

Accordingly, one or more embodiments prioritize incidents associated with CSRs and the CSRs themselves. One or more embodiments establish a hierarchy among the events in sets of citizen censor events. Priority levels are assigned to these events based upon distinct characteristics of CSRs (e.g. time-sensitiveness, open environment context, end-user profile and end-user reputation) in combination with generated user reputation values/rates and parameters of local context. This allows for incidents and CSRs associated with a higher priority to be identified an promptly handled over incidents and CSRs associated with a lower priority.

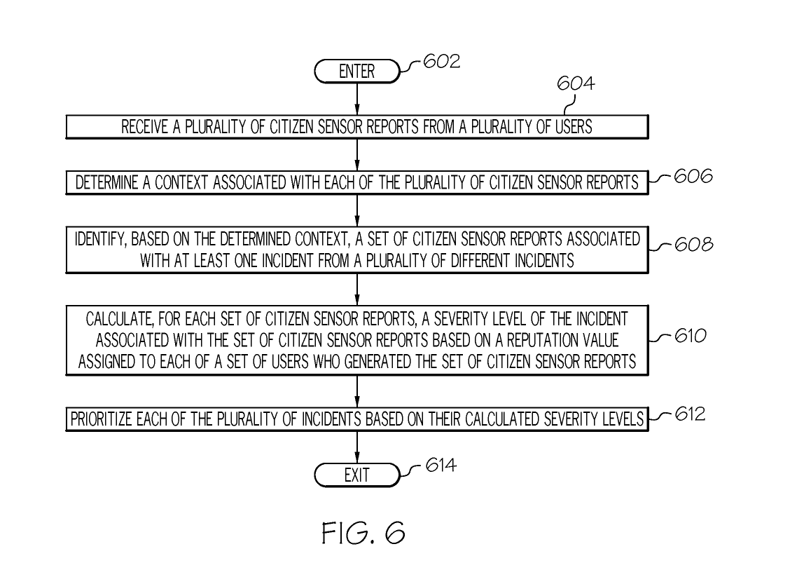

FIG. 6 is an operational flow diagram illustrating one example of an overall process for predicting satisfaction level (a utility function) of service provider. The operational flow diagram of FIG. 6 begins at step 602 and flows directly to step 604. The priority level manager 112, at step 604, receives a plurality of citizen sensor reports 114 from a plurality of users. The priority level manager 112, at step 606, determines a context associated with each of the plurality of citizen sensor reports 114. The priority level manager 112, at step 608, identifies, based on the determined context, a set of citizen sensor reports 114 associated with at least one incident from a plurality of different incidents. The priority level manager 112, at step 610, calculates, for each set of citizen sensor reports 114, a severity level 314 of the incident associated with the set of citizen sensor reports 114 based on a reputation value 312 assigned to each of a set of users who generated the set of citizen sensor reports 114. The priority level manager 112, at step 612, prioritizes each of the plurality of incidents based on their calculated severity levels 314. The control flow exits at step 614.

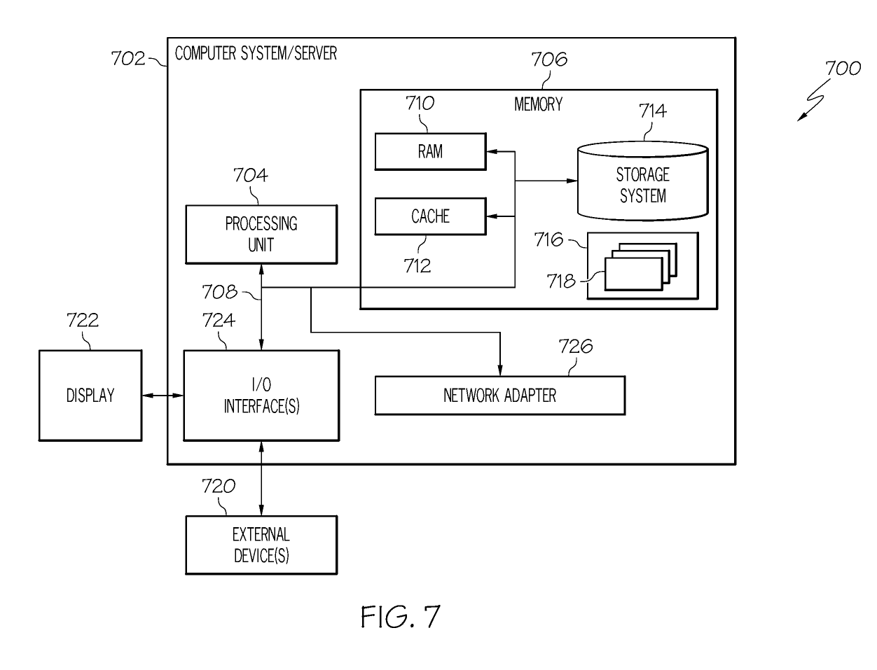

FIG. 7 shows a block diagram illustrating an information processing system 700 that can be utilized in various embodiments of the present disclosure such as the information processing system 104 shown in FIG. 1. The information processing system 702 is based upon a suitably configured processing system configured to implement one or more embodiments of the present disclosure. Any suitably configured processing system can be used as the information processing system 702 in embodiments of the present disclosure. The components of the information processing system 702 can include, but are not limited to, one or more processors or processing units 704, a system memory 706, and a bus 708 that couples various system components including the system memory 706 to the processor 704.

The bus 708 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 7, the main memory 706 includes at least the ranking manager 114 and its components shown in FIG. 1. Each of these components can reside within the processor 704, or be a separate hardware component. The system memory 706 can also include computer system readable media in the form of volatile memory, such as random access memory (RAM) 710 and/or cache memory 712. The information processing system 702 can further include other removable/non-removable, volatile/non-volatile computer system storage media. By way of example only, a storage system 714 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 708 by one or more data media interfaces. The memory 706 can include at least one program product having a set of program modules that are configured to carry out the functions of an embodiment of the present disclosure.

Program/utility 716, having a set of program modules 718, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules 718 generally carry out the functions and/or methodologies of embodiments of the present disclosure.

The information processing system 702 can also communicate with one or more external devices 720 such as a keyboard, a pointing device, a display 722, etc.; one or more devices that enable a user to interact with the information processing system 702; and/or any devices (e.g., network card, modem, etc.) that enable computer system/server 702 to communicate with one or more other computing devices. Such communication can occur via I/O interfaces 724. Still yet, the information processing system 702 can communicate with one or more networks such as a local area network (LAN), a general wide area network (WAN), and/or a public network (e.g., the Internet) via network adapter 726. As depicted, the network adapter 726 communicates with the other components of information processing system 702 via the bus 708. Other hardware and/or software components can also be used in conjunction with the information processing system 702. Examples include, but are not limited to: microcode, device drivers, redundant processing units, external disk drive arrays, RAID systems, tape drives, and data archival storage systems.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for prioritizing incidents associated with citizen sensor reports, the method comprising:
receiving a plurality of citizen sensor reports from a plurality of users;
determining a context associated with each of the plurality of citizen sensor reports;
identifying, based on the determined context, a set of citizen sensor reports associated with at least one incident from a plurality of different incidents;
calculating, for each set of citizen sensor reports, a severity level of the incident associated with the set of citizen sensor reports based on a reputation value assigned to each of a set of users who generated the set of citizen sensor reports; and
prioritizing each of the plurality of incidents based on their calculated severity levels.

2. The method of claim 1, wherein the determining comprises:
analyzing a set of context information included within each of the plurality of citizen sensor reports, wherein the set of context information comprises at least time, location, and reporting target information.

3. The method of claim 1, wherein the identifying comprises:
comparing the context associated with each of the plurality of citizen sensor reports;
identifying, based on the comparing, two or more citizen sensor reports associated with a context matching within a given threshold; and
classifying the two or more citizen sensor reports as being associated with a similar incident.

4. The method of claim 1, wherein the calculating further comprises:
analyzing, for each of the set of users, a user profile associated with the user, wherein the user profile at least comprises historical information associated with previous citizen sensor reports generated by the user; and
calculating, based on the analyzing, the reputation value for the user.

5. The method of claim 4, wherein the calculating further comprises:
calculating the severity level as a function of a sum of each reputation value calculated for each of the set of users.

6. The method of claim 1, further comprising:
prioritizing, for at least one of the sets of citizen sensor reports, each of the citizen sensor reports in the set of citizen sensor reports based on reputation value assigned to each of the set of users.

7. The method of claim 6, wherein prioritizing each of the citizen sensor reports comprises:
comparing the reputation value assigned to each of the set of users; and
assigning, based on the comparing, a priority level to each of the citizen sensor reports in the set of citizen sensor reports, where a first citizen sensor report associated with a first reputation value that is higher than a second reputation value associated with a second citizen sensor report is assigned a higher priority level than the second citizen sensor report.

8. An information processing system for prioritizing incidents associated with citizen sensor reports, the information processing system comprising:
memory;
a processor communicatively coupled to the memory; and
a priority level manager communicatively coupled to the memory and the processor, wherein the priority level manager is configured to perform a method comprising:
receiving a plurality of citizen sensor reports from a plurality of users;
determining a context associated with each of the plurality of citizen sensor reports;
identifying, based on the determined context, a set of citizen sensor reports associated with at least one incident from a plurality of different incidents;
calculating, for each set of citizen sensor reports, a severity level of the incident associated with the set of citizen sensor reports based on a reputation value assigned to each of a set of users who generated the set of citizen sensor reports; and
prioritizing each of the plurality of incidents based on their calculated severity levels.

9. The information processing system of claim 8, wherein the identifying comprises:
comparing the context associated with each of the plurality of citizen sensor reports;
identifying, based on the comparing, two or more citizen sensor reports associated with a context matching within a given threshold; and
classifying the two or more citizen sensor reports as being associated with a similar incident.

10. The information processing system of claim 8, wherein the calculating further comprises:
analyzing, for each of the set of users, a user profile associated with the user, wherein the user profile at least comprises historical information associated with previous citizen sensor reports generated by the user; and
calculating, based on the analyzing, the reputation value for the user.

11. The information processing system of claim 10, wherein the calculating further comprises:
calculating the severity level as a function of a sum of each reputation value calculated for each of the set of users.

12. The information processing system of claim 8, further comprising:
prioritizing, for at least one of the sets of citizen sensor reports, each of the citizen sensor reports in the set of citizen sensor reports based on reputation value assigned to each of the set of users.

13. The information processing system of claim 12, wherein prioritizing each of the citizen sensor reports comprises:
comparing the reputation value assigned to each of the set of users; and
assigning, based on the comparing, a priority level to each of the citizen sensor reports in the set of citizen sensor reports, where a first citizen sensor report associated with a first reputation value that is higher than a second reputation value associated with a second citizen sensor report is assigned a higher priority level than the second citizen sensor report.

14. A computer program product for prioritizing incidents associated with citizen sensor reports, the computer program product comprising:
a storage medium readable by a processing circuit and storing instructions for execution by the processing circuit for performing a method comprising:
receiving a plurality of citizen sensor reports from a plurality of users;
determining a context associated with each of the plurality of citizen sensor reports;
identifying, based on the determined context, a set of citizen sensor reports associated with at least one incident from a plurality of different incidents;
calculating, for each set of citizen sensor reports, a severity level of the incident associated with the set of citizen sensor reports based on a reputation value assigned to each of a set of users who generated the set of citizen sensor reports; and
prioritizing each of the plurality of incidents based on their calculated severity levels.

15. The computer program product of claim 14, wherein the determining comprises:
analyzing a set of context information included within each of the plurality of citizen sensor reports, wherein the set of context information comprises at least time, location, and reporting target information.

16. The computer program product of claim 14, wherein the identifying comprises:
comparing the context associated with each of the plurality of citizen sensor reports;
identifying, based on the comparing, two or more citizen sensor reports associated with a context matching within a given threshold; and
classifying the two or more citizen sensor reports as being associated with a similar incident.

17. The computer program product of claim 14, wherein the calculating further comprises:
analyzing, for each of the set of users, a user profile associated with the user, wherein the user profile at least comprises historical information associated with previous citizen sensor reports generated by the user; and
calculating, based on the analyzing, the reputation value for the user.

18. The computer program product of claim 17, wherein the calculating further comprises:
calculating the severity level as a function of a sum of each reputation value calculated for each of the set of users.

19. The computer program product of claim 14, further comprising:
prioritizing, for at least one of the sets of citizen sensor reports, each of the citizen sensor reports in the set of citizen sensor reports based on reputation value assigned to each of the set of users.

20. The computer program product of claim 19, wherein prioritizing each of the citizen sensor reports comprises:
comparing the reputation value assigned to each of the set of users; and
assigning, based on the comparing, a priority level to each of the citizen sensor reports in the set of citizen sensor reports, where a first citizen sensor report associated with a first reputation value that is higher than a second reputation value associated with a second citizen sensor report is assigned a higher priority level than the second citizen sensor report.
